(19) United States
(12) Patent Application Publication
(10) Pub. No.: US 2024/0352367 A1
(43) Pub. Date: Oct. 24, 2024

(54) THIOUREA FROM SOUR HYDROCARBON GAS

(71) Applicant: THG, LLC, Milwaukie, OR (US)

(72) Inventors: J. Dustin HULTINE, Milwaukie, OR (US); Robert Kurt GRAUPNER, Hillsboro, OR (US)

(21) Appl. No.: 18/758,674

(22) Filed: Jun. 28, 2024

Related U.S. Application Data
(63) Continuation-in-part of application No. PCT/US2022/079933, filed on Nov. 16, 2022.
Application No. PCT/US2022/079933 is a continuation of application No. 17/932,814, filed on Sep. 16, 2022, now Pat. No. 11,591,533.
(63) Continuation-in-part of application No. 18/533,794, filed on Dec. 8, 2023.
(60) Provisional application No. 63/266,456, filed on Jan. 5, 2022.
(60) Provisional application No. 63/386,807, filed on Dec. 9, 2022.

(51) Int. Cl. C10L 3/10; B01D 53/04; B01D 53/14

(52) U.S. Cl. CPC C10L 3/103; B01D 53/0438; B01D 53/1468; B01D 2253/112; B01D 2257/304

(57) ABSTRACT

A method to purify a hydrocarbon gas comprises: (a) obtaining the hydrocarbon gas, such hydrocarbon gas having hydrogen sulfide as an impurity; (b) charging a chamber with a bed of active-metal carbide of a predetermined mesh-size range; (c) conducting the hydrocarbon gas through the bed of active-metal carbide, forming additional hydrocarbon gas and a sulfide of the active metal, by reaction of the active-metal carbide and the hydrogen sulfide; (d) filtering from the chamber the hydrocarbon gas without the hydrogen sulfide; and (e) treating the sulfide of the active metal with a cyanamide compound and an acid, thereby forming thiourea.

### CROSS REFERENCE TO RELATED APPLICATIONS

This application is a continuation-in-part of International Patent Application Serial Number PCT/US2022/079933 filed 16 Nov. 2022, which is a continuation of U.S. Non-Provisional patent application Ser. No. 17/932,814, filed 16 Sep. 2022, which claims priority to U.S. Provisional Patent Application Ser. No. 63/266,456 filed 5 Jan. 2022. This application is also a continuation-in-part of U.S. Non-Provisional patent application Ser. No. 18/533,794 filed 8 Dec. 2023, which claims priority to U.S. Provisional Patent Application Ser. No. 63/386,807 filed 9 Dec. 2022. The entirety of each of the above-referenced applications is hereby incorporated herein by reference for all purposes.

### TECHNICAL FIELD

This disclosure relates generally to the field of chemical engineering and more specifically to purification of hydrocarbon gases.

### BRIEF DESCRIPTION OF THE DRAWINGS

FIG. 1 shows aspects of an example gas-treatment facility for purifying a hydrocarbon gas.

FIG. 2 shows aspects of an example acid scrubber configured to subject hydrocarbon gas to amine treatment.

FIG. 3 shows aspects of another kind of acid scrubber in one, non-limiting example.

FIG. 4 shows aspects of an example method to purify a hydrocarbon gas with hydrogen sulfide as an impurity.

FIG. 5 shows aspects of an example method for making an active-metal carbide suitable for use in the hydrocarbon-purification methods herein and related methods.

FIG. 6 shows aspects of an example carbide unit usable in connection to the method of FIG. 5.

FIG. 7 shows aspects of yet another kind of acid scrubber in one, non-limiting example.

FIG. 8 shows aspects of an example feedstock-preparation system usable in connection to the method of FIG. 5.

FIGS. 9A and 9B show aspects of example feedstock-reactor systems in connection to the method of FIG. 5.

FIG. 10 shows aspects of another example method to purify a hydrocarbon gas with hydrogen sulfide as an impurity.

FIG. 11 shows aspects of an example processing facility for purifying a hydrocarbon gas.

### DETAILED DESCRIPTION

Hydrocarbon gases are valuable as fuels and as starting materials for chemical synthesis. The term ‘hydrocarbon gas’ refers herein to any gas including, as a primary component, one or more chemical compounds CₓH_{y}, where x and y are each greater than or equal to one. Such chemical compounds are ‘hydrocarbons’ if they comprise no chemical element other than carbon and hydrogen. Hydrocarbons may include unsaturated alkanes and also alkenes and alkynes of any degree of unsaturation. Hydrocarbons may be branched, non-branched, cyclic, acyclic, aliphatic, and/or aromatic. The term ‘hydrocarbon gas’ should not be construed to limit the boiling point of the hydrocarbons therein; it does not require (nor does it proscribe) that the hydrocarbons are gases at standard temperature and pressure (STP). In some stages of refinement, a hydrocarbon gas may also include, in addition to the primary hydrocarbon component, substances that are not hydrocarbons.

The skilled reader will appreciate that practically all organic chemicals and synthetic polymers are manufactured from petroleum hydrocarbons as initial starting materials. Indeed most commodity organic chemicals are sourced from petroleum at low cost and high efficiency. That in itself is a sound reason to discourage depletion of petroleum resources globally, for sourcing commodity organic chemicals from the biosphere would be astronomically more expensive and more burdensome environmentally. Nevertheless, the vast majority of the hydrocarbon extracted from the earth is used as fuel. Hydrocarbons release their energy conveniently via combustion and are among the most energy-dense fuels that exist. Moreover, hydrocarbons are easy to store and transport. In many parts of the world, the most abundant and least expensive hydrocarbon fuels are hydrocarbon gases.

The various modes of global hydrocarbon consumption can be re-examined through the lens of anthropogenic climate change. Generally speaking, turning hydrocarbons into materials and commodity chemicals other than fuel can be carbon-neutral. Moreover, in scenarios in which a volatile hydrocarbon would otherwise be released into the atmosphere (notably methane which has a high global-heating effect), harvesting the hydrocarbon to avert its release may be advantageous no matter the end use. By contrast, combustion of hydrocarbons harvested from below the biosphere is carbon-positive, as carbon dioxide (CO2) is invariably released into the atmosphere,

CₓH_{y}+(x+y/4)O₂→xCO₂+y/2H₂O, (1)

Combustion of hydrocarbons derived from biomass has at least the potential of being carbon-neutral, assuming that the biomass is ultimately replenished via photosynthesis. In view of the context above, some species of hydrocarbon gases are enumerated below.

‘Natural gas’ is hydrocarbon gas from a well, comprising mostly methane. ‘Biomethane’ is hydrocarbon gas from anaerobic digestion of biomass. ‘Cow gas’ or ‘livestock-waste digester gas’ is biomethane sourced particularly from the livestock industry. ‘Sewer gas’ is biomethane from human bodily discharge. ‘Flare gas’ is excess hydrocarbon gas released in petroleum drilling or refinement or biodiesel production. Flare gas is also emitted by sewage digesters and coal gasification, and other industrial processes. ‘Producer gas’ is not a hydrocarbon gas per se but is applicable to the methods herein. Producer gas is a mixture comprising carbon monoxide (CO) and hydrogen (H₂), which derives from the gasification of solid organic matter such as coal, wood, lignin, and other forms of biomass. In some scenarios producer gas may be used as fuel. In other scenarios producer gas may be reformed to yield ‘reformer’ or ‘synthesis’ gas, which comprises methane and is therefore a hydrocarbon gas. Some reforming and/or gasification strategies add hydrogen to the producer gas, the hydrogen reducing carbon monoxide and enriching the hydrocarbon content of the gas. In some scenarios such hydrogen may derive from a non-hydrocarbon (e.g., electrolytic) source.

The hydrocarbon gases listed above natively comprise at least some non-hydrocarbon substances that may be undesirable for end use or downstream processing. Example non-hydrocarbon substances include water vapor, carbon dioxide carbon monoxide, hydrogen, nitrogen (N₂), ammonia (NH₃), hydrogen sulfide (H₂S), mercury, and mercury compounds. Accordingly, hydrocarbon gas may be admitted to a gas-treatment facility to reduce the levels of one or more of these substances.

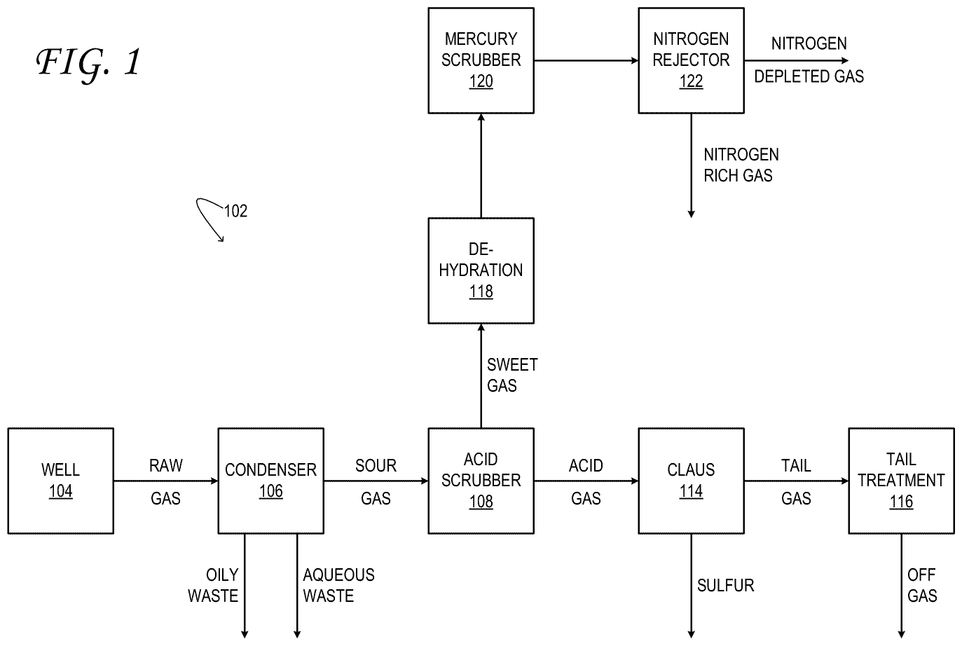

FIG. 1 shows aspects of an example gas-treatment facility 102 suitable for purifying a hydrocarbon gas. In facility 102, raw gas from well 104 is conducted to condenser unit 106, where oily waste and aqueous waste are separated from the raw gas via condensation. The sour gas emerging from the condenser unit is then conducted to acid scrubber 108. Traditionally an acid scrubber may enact one or more of amine treatment, Benfield processing, pressure-swing adsorption (PSA) processing, or sulfinol processing.

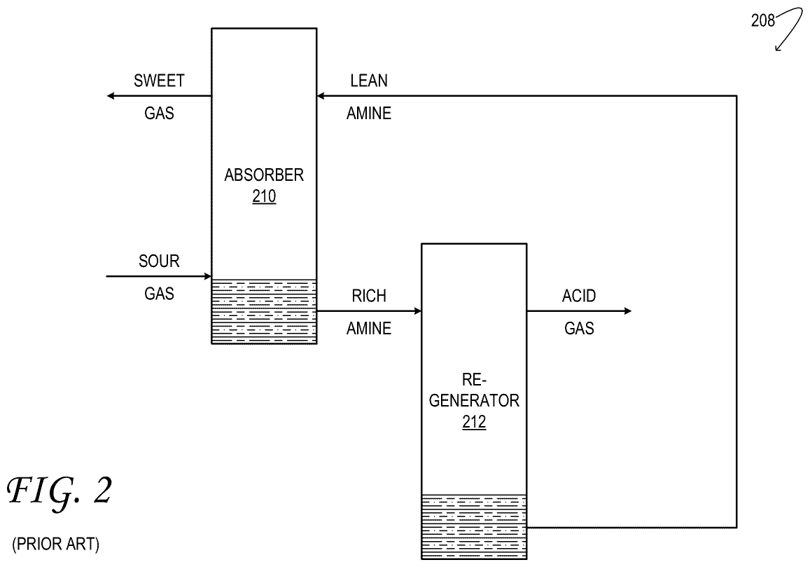

FIG. 2 shows aspects of an example acid scrubber 208 configured to subject sour hydrocarbon gas to amine treatment. Acid scrubber 208 includes absorber 210 and regenerator 212. The absorber exposes the sour gas to an amine solution and releases sweet hydrocarbon gas. The regenerator receives the amine solution enriched with absorbed acids, such as hydrogen sulfide, boils off and then condenses the acids into an ‘acid gas’, and returns lean amine to absorber 210.

Returning now to FIG. 1, the acid gas separated from the sour gas stream is conducted to Claus unit 114, where the Claus process is used to oxidize entrained hydrogen sulfide into elemental sulfur. The Claus unit oxidizes the hydrogen sulfide in a multi-step process, involving thermal and catalytic processing. Tail gas emerging from the Claus unit is further processed in tail-treatment unit 116, which may use Scot, Clauspol, or other processing prior to incineration of the ‘off-gas’ discharge.

From acid scrubber 108, sweet hydrocarbon gas is conducted to dehydration unit 118, which may include a glycol and/or PSA unit, for example. The dehydrated sweet-gas effluent is conveyed to mercury scrubber 120, which may use molecular sieves and/or activated carbon to remove mercury and mercury compounds. Mercury-free, dehydrated sweet gas is then conveyed to nitrogen rejector 122, which uses adsorption, absorption, and/or a cryogenic process to separate the sweet gas into nitrogen-rich and nitrogen-depleted hydrocarbon-gas streams.

Of particular interest in gas-treatment facility 102 is removal of hydrogen sulfide. In scenarios in which the hydrocarbon gas is to be used in a catalytic process (e.g., reforming), removal of hydrogen sulfide is greatly desirable, as sulfur can poison (i.e., deactivate) various heterogeneous catalysts. Even if the hydrocarbon gas is to be burned in a furnace, engine, or turbine, removal of hydrogen sulfide is desirable so as to avoid the formation and release of SO₂ and SO₃ pollutants. Atmospheric SO₂ and SO₃ are known to acidify rain water-e.g.,

SO₃+2H₂O→H₃O⁺+HSO₄₋, (2)

which adversely affects ecosystems. Furthermore, in the context of anthropogenic climate change, hydronium (H₃O⁺) from rain water is believed to reduce the pH of surface water, releasing CO₂ from submerged carbonate minerals and limiting CO₂ absorption from the atmosphere. Further still, in some scenarios a hydrocarbon gas may contain so much hydrogen sulfide that recovery of the sulfur has non-negligible economic value (vide infra).

As noted hereinabove, in gas-treatment facility 102, hydrogen sulfide can be removed from sour hydrocarbon gas via acid scrubber 208 in conjunction with Claus unit 114. While FIG. 2 provides only a schematic illustration, the skilled reader will appreciate that a state-of-the-art acid scrubber is a large, complex, and expensive unit—factors that may limit its application to high-volume hydrocarbon-gas sources, where capital investment in the acid scrubber is offset by sweet-gas throughput. Conversely, the expense and complexity of the acid scrubber may discourage the harvesting of other valuable sources of hydrocarbon gas, especially stranded sources. Investment in state-of-the-art acid scrubbing may be even harder to justify economically for very low-value hydrocarbon gases, such as flare gas, even when available in large quantities. This is discouraging, because flare-gas incineration, which is typically incomplete, may emit carbon monoxide, formaldehyde, polycyclic aromatic hydrocarbons, acetaldehyde, acrolein, propylene, toluene, xylenes, ethyl benzene and/or hexane. Moreover, because the combustion exhaust is typically untreated, nitrogen oxides may also be released. The inventors herein have recognized these disadvantages and have devised an alternative solution.

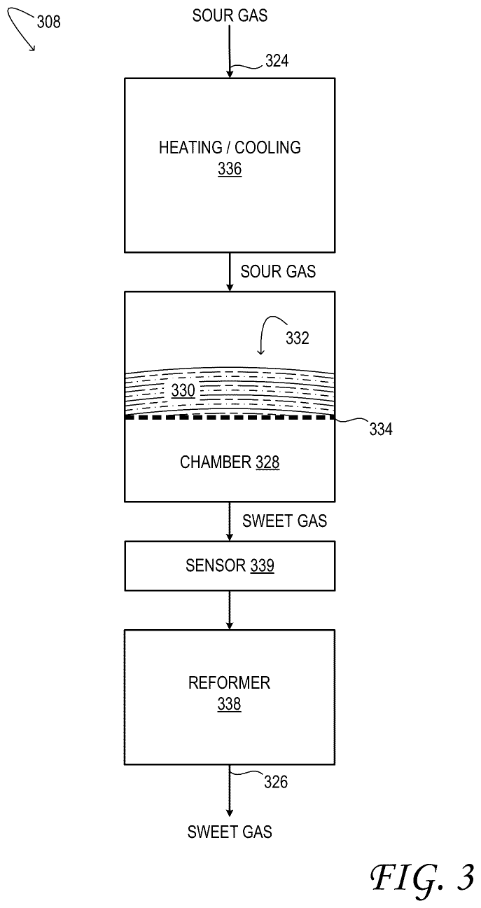

FIG. 3 shows aspects of another example acid scrubber 308, configured to purify a hydrocarbon gas with hydrogen sulfide as an impurity. Acid scrubber 308 includes an inlet 324 for receiving sour gas and an outlet 326 for releasing sweet gas. Chamber 328 is arranged fluidically downstream of the inlet and upstream of the outlet. The chamber is configured to receive a flow of the sour hydrocarbon gas. Bed 330 is arranged within chamber 328. The bed is configured to intercept the flow of the sour hydrocarbon gas, such that the hydrocarbon gas must percolate through the bed in order to reach the outlet.

Bed 330 includes a particulate form of an active-metal carbide 332. More specifically, active-metal carbide of a predetermined mesh-size range is arranged in the bed. The predetermined mesh-size range may be 10 to 50 mesh in some examples. In other examples, the predetermined mesh-size range may be finer or coarser, broader or narrower. As used herein, the term ‘active metal’ refers generically to metallic elements of groups IA and IIA of the Periodic Table of the Elements, which form substantially ionic carbides. In more particular examples, this term is restricted to relatively abundant and toxicologically and environmentally benign elements from groups IA and IIA—such as sodium, potassium, magnesium, and calcium. In some examples, accordingly, active-metal carbide 332 comprises a substantially ionic acetylide such as calcium carbide (CaC₂) or sodium acetylide (Na₂C₂). Acetylides are so named because they form acetylene (HCCH) on hydrolysis. In some examples, active-metal carbide 332 comprises a substantially ionic methide such as magnesium methide (Mg₂C). Methides are so named because they form methane on hydrolysis. In some examples, active-metal carbide 332 comprises a substantially ionic allylide such as magnesium sesquicarbide (Mg₂C₃). Allylides are so named because they form the allenes methylacetylene (CH₃CCH) and propadiene (CH₂CCH₂) on hydrolysis. In some examples, active-metal carbide 332 may include a mixture of carbides of different active metals.

The inventors herein reason that each of the carbide anions, C₂²⁻, C⁴⁻, and C₃⁴⁻, is a very strong Lewis base. As such, substantially ionic active-metal carbides will react with Lewis acids that may be present in sour hydrocarbon gas. For example, by passing hydrocarbon gas through or over a bed of particulate calcium carbide, the following transformation is expected:

H₂S+CaC₂→CaS+HCCH, (3)

In that spirit, active-metal carbide 332 is configured to form additional hydrocarbon gas by reaction with the hydrogen sulfide impurity of the sour hydrocarbon gas. The additional hydrocarbon gas may comprise acetylene, methane, methylacetylene and/or propadiene (CH₂CCH₂), for example. In some examples the active-metal carbide is configured to form still more hydrocarbon gas by reaction with one or more acid impurities of sour hydrocarbon gas besides hydrogen sulfide.

In a typical implementation, the sour hydrocarbon gas is passed through the active-metal carbide in a particulate state. A stirred bed may be used so as to expose the hydrocarbon gas to a fresh surface of the active-metal carbide and thereby promote heterogeneous reaction. In the illustrated example, acid scrubber 308 includes filter 334. Arranged in chamber 328 fluidically downstream of bed 330, filter 334 is configured to retain active-metal carbide 332 and to transmit sweet hydrocarbon gas without the hydrogen sulfide. In other words, the hydrogen sulfide may be eliminated, substantially eliminated, or reduced significantly in partial pressure. The filter is used to prevent the active-metal carbide particulate from being entrained in the sweet hydrocarbon gas exiting the chamber.

In some examples active-metal carbide 332 may react with acid components of the sour gas occur at ambient temperature. In other examples, elevated or reduced temperatures may be desired. Elevated temperatures may be used to accelerate the reaction—e.g., when the amount of active-metal carbide in the bed nears depletion. Reduced temperatures may be used to discourage thermal runaway, for instance, in the event that the sour gas comprises a high concentration of acid impurities that react exothermically with the active-metal carbide. In the illustrated example, accordingly, acid scrubber 308 includes a heating and/or cooling unit 336 arranged fluidically upstream of chamber 328. In some examples the heating and/or cooling unit may comprise a heat exchanger configured to adjust the temperature of the sour hydrocarbon gas being purified. In some examples the heating and/or cooling unit may comprise a furnace or resistive heater. In some examples the heating and/or cooling unit may comprise a gas-gas or gas-liquid heat exchanger.

Effective ‘conversion’ of hydrogen sulfide to the additional hydrocarbon gas is useful in scenarios in which the hydrocarbon gas is to be used as fuel, because the additional hydrocarbon gas may be an acceptable addition to the fuel, in the amounts in which it would be produced. In examples in which unsaturated hydrocarbons such as acetylene, methylacetylene and/or propadiene are not a desirable addition to the sweet hydrocarbon gas, the unsaturated hydrocarbons can be saturated by reaction with hydrogen in a downstream reformer—e.g.,

HCCH+2H₂→CH₃CH₃, (4)

Accordingly, in the illustrated example acid scrubber 308 includes an optional reformer 338 arranged fluidically downstream of optional sensor 339, which is downstream of chamber 328. A ‘reformer’ herein may be any state-of-the-art unit configured for one or more of hydrogenation, dehydrogenation, hydrogenolysis, hydrocracking, catalytic reforming, methane reforming, steam reforming, and/or autothermal reforming of a hydrocarbon gas. The term ‘reforming conditions’ refers analogously to the physicochemical conditions (e.g., pressure, temperature, catalyst) within a reformer as defined herein. The sensor may be configured to emit an output signal responsive to the partial pressure of any predetermined component of the effluent from chamber 328—e.g., an unsaturated hydrocarbon or an acid impurity such as hydrogen sulfide. The output signal may be used as a control input in the purification process.

Although acid scrubber 308 is configured primarily to scrub H₂S from hydrocarbon gas, it may scrub practically any Lewis acid. In a scenario in which upstream scrubbing of water vapor is incomplete, further dehydration is accomplished in the same bed—e.g.,

H₂O+CaC₂→CaO+HCCH, (5)

releasing additional acetylene into the purified product. It will be noted that exposure of active-metal carbide 332 to acids stronger than hydrogen sulfide should be limited, however, so as to prevent re-release of hydrogen sulfide from bound calcium sulfide (CaS).

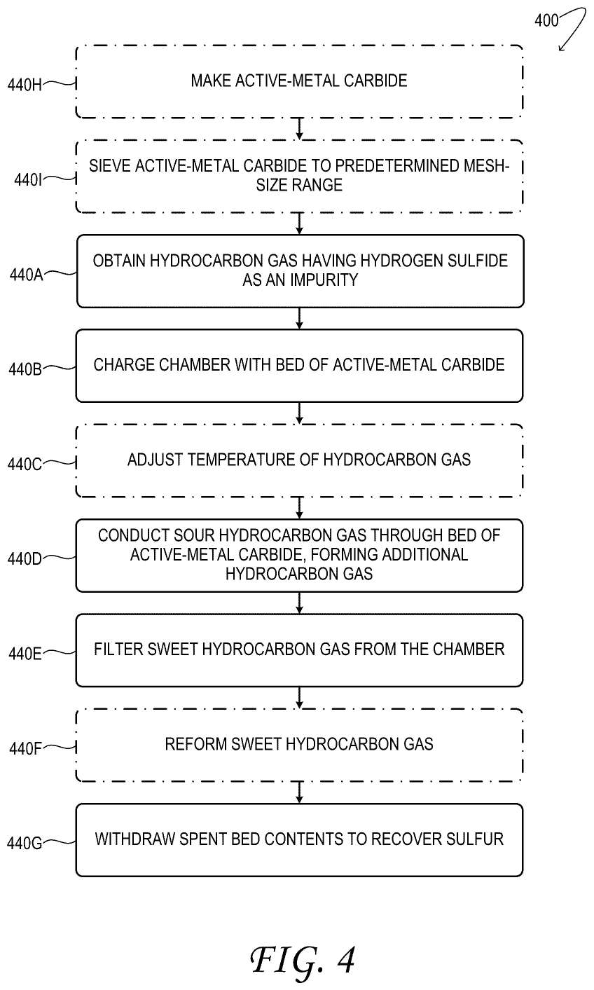

FIG. 4 shows aspects of an example method 400 to purify a hydrocarbon gas with hydrogen sulfide as an impurity. The purification strategies herein are especially suitable for stranded sources of hydrocarbon gas, because they can be completely or substantially self-contained.

At 440A of method 400 a hydrocarbon gas is obtained. The hydrocarbon gas is a gas having hydrogen sulfide as an impurity. The hydrocarbon gas may be obtained from a well or other process, as described hereinabove. At 440B a chamber is charged with a bed of active-metal carbide of a predetermined mesh-size range. In some examples the active-metal carbide includes calcium carbide and/or a magnesium carbide. In some examples the mesh size of the active-metal carbide is 10 to 50 mesh.

At optional step 440C the temperature of a sour hydrocarbon-gas stream is adjusted before the sour hydrocarbon gas is conducted, at 440D, through the bed of active-metal carbide. In some examples and scenarios the temperature may be increased; in other examples and scenarios the temperature may be decreased. For instance, the temperature may be adjusted to within a suitable range.

The sour hydrocarbon gas is then conducted through the bed of active-metal carbide, forming additional hydrocarbon gas by reaction of the active-metal carbide and the hydrogen sulfide. In some examples conducting the sour hydrocarbon gas through the bed of the active-metal carbide comprises conducting at ambient temperature. In some examples, still more hydrocarbon gas is formed by acidification of the active-metal carbide with one or more acid impurities of the sour hydrocarbon gas besides hydrogen sulfide. In some examples conducting the sour hydrocarbon gas through the bed includes active pressurization—i.e., pumping. In some examples, the bed of active-metal carbide is configured to provide minimal fluidic resistance to transmission of the hydrocarbon gas, for higher throughput at lower levels of pressurization. In some examples the sour hydrocarbon gas may be conducted under conditions of controlled mass flow. In some examples, where an H₂S sensor is arranged fluidically downstream of the bed of active-metal carbide, the hydrocarbon flow rate and/or temperature may be varied in a closed-loop manner so as to limit the partial pressure of H₂S in the effluent to an acceptable range. For instance, the temperature may be increased and/or the flow rate decreased with increasing partial pressure of H₂S; conversely, the temperature may be decreased and/or the flow rate increased with decreasing partial pressure of H₂S. This strategy may be used to balance purification and throughput objectives. In other examples, sensory output may be applied for closed-loop control of reforming conditions, etc.

At 440E sweet hydrocarbon gas without the hydrogen sulfide (vide supra) is filtered from the chamber. At optional step 440F the purified hydrocarbon gas is subjected to reforming conditions to saturate any unsaturated hydrocarbons that may be present in the sweet hydrocarbon gas. At 440G, at suitable intervals, the contents of the bed are withdrawn from the chamber for recovery of the sulfur immobilized therein. In some examples, this action can be coordinated with refilling the bed with fresh active-metal carbide. In some examples, the spent bed may be acidified:

H₂CO₃+CaC₂→CaCO₃+HCCH, (6)

H₂CO₃+CaS→CaCO₃+H₂S. (7)

The bed may be acidified fluidically upstream of a Claus unit (vide supra), so that the sulfur can be recovered using existing technology. Numerous mineral acids are strong enough to effect transformations analogous to Eqs 6 and 7, but carbonic acid is advantageous because the active-metal oxide is easily recovered by heating the carbonate by-product—e.g.,

CaCO₃→CaO+CO₂. (8)

It should be noted that the global supply of sulfur relies heavily on recovery from petroleum. As a result, any significant reduction in petroleum output (to reduce carbon emissions, for instance) is liable to increase the scarcity of sulfur and encourage environmentally deleterious mining activity. That hypothetical scenario provides additional motivation to reduce the cost of H₂S scrubbing and extend scrubbing technology to stranded, low-volume, and/or low-value sources of hydrocarbon gas.

Continuing in FIG. 4, in some implementations, purification method 400 may include the optional step 440H of making the active-metal carbide. The active-metal carbide could be made in the same processing facility at which the hydrocarbon gas is purified, for instance. At optional step 440I the active-metal carbide is sieved to a predetermined mesh-size range, as noted hereinabove.

This disclosure presents, inter alia, technology for recycling certain kinds of agricultural, industrial, and consumer wastes and for integrating the recycled products, including energy, into environmentally sustainable industrial solutions. The wastes relevant to this disclosure contain carbon; the carbon is used to convert an active-metal oxide (e.g., lime, CaO) into a corresponding carbide (e.g., CaC₂). Formed at high temperatures in an electric-arc furnace, active-metal carbides are valuable, high-energy chemical synthons.

In state-of-the-art carbide synthesis, amorphous elemental carbon (e.g., coke) is the carbon source,

CaO+3C→CaC₂+CO. (9)

The inventors herein have discovered that certain other carbon sources, including waste products, can be used in place of coke. Various carbon-containing materials pyrolyze at high temperatures to yield carbon char and one or more volatile by-products. The carbon char supports carbide formation, while the volatile by-products are discharged from the furnace as gaseous effluent, along with the CO from Eq 9. In examples in which the carbon-containing material is a carbohydrate, water is released into the effluent—e.g.,

CaO+3/n(CH₂O)ₙ→CaC₂+CO+H₂O. (10)

Example carbohydrate wastes suitable for recycling in this manner include agricultural wastes such as chaff and stover from grain crops, straw, bedding, and/or other agricultural/silvicultural plant material. To limit undesired cooling of the furnace by emission of steam, the carbohydrate waste may be dried and/or dehydrated upstream of the furnace. In some examples, carbohydrate waste may be dehydrated at 200 to 400° C. In some examples, the dehydration conditions may liberate volatiles such as hydrogen sulfide (H₂S) from the waste. The H₂S can be separated from the water vapor and its sulfur and/or hydrogen content recovered.

Another carbon-containing waste material suitable for recycling is lignin, which, in view of its empirical formula, may function in the furnace as a partially dehydrated carbohydrate. Other suitable carbon-containing materials—consumer wastes such as waste plastic, motor-vehicle tires, and asphaltic shingles—comprise much more hydrogen than oxygen. In examples in which the carbon-containing material is waste plastic, hydrogen is released in the effluent—e.g.,

CaO+3/n(CH₂)ₙ→CaC₂+CO+H₂. (11)

In these and other examples, both the carbide residue and the gaseous effluent have value. Historically, carbides are important agents for fixing atmospheric nitrogen. In particular, CaC₂ is converted into calcium cyanamide (CaCN₂) via the Frank-Caro process,

CaC2+N₂→CaCN₂+C. (12)

The effluent from the furnace in which CaC₂ is made may have further value due to its reducing capacity. Mixtures comprising CO and/or hydrogen have significant free energy of combustion, which can be released in various ways (e.g., oxidation) to provide high-quality energy. In some examples the total available energy is believed to exceed the energy required to power the arc furnace in which the carbide product is formed, even excluding the significant free energy of formation of CaC₂ relative to CaO. CaC₂ is produced industrially for 509 KJ/mol. The heats of combustion of the CO and H₂ from Eq 11 combine to 1141 kJ/mol. If that amount of heat could be converted to useful work at only 45 percent efficiency, then the process would break even energetically. With more efficient (e.g., non-thermal) energy capture, surplus energy would be available. Thus, Eq 11 can be described as a way to turn waste plastic and lime into CaC₂ and energy.

In examples in which the effluent from the furnace comprises a significant amount of hydrogen, its free energy of combustion may be extracted via a hydrogen-air fuel cell. The efficiency of a hydrogen-air fuel cell with a combined heat power (CHP) system can be over 80 percent. In some examples, any, some, or all of the reducing capacity of the effluent may be converted into hydrogen via the water gas shift (WGS) reaction,

CO+H₂O→CO₂+H₂. (13)

Various charable carbon sources—plastics, lignin, and forest biomass, for example—pyrolyze at suitably high temperatures to yield mixtures of CO and H₂ (syngas, effectively). As noted herein, the syngas can be subjected to WGS conditions to yield bio-neutral H₂, which can be used in various ways. One potential end-use is as a fuel source for H₂-powered watercraft, including large ocean-going vessels. An additional advantage of this application is that the CO₂ by-product of the WGS reaction is also bio-neutral. Currently the cost of electrolytic hydrogen is very high, due in part to the intrinsically high overpotential for the O₂/H₂O couple. The technologies herein avoid the inefficiencies of that method while retaining bio-neutrality.

In some examples, the effluent from the arc furnace may have further value due to its carbon content. Instead of subjecting all of the CO to combustion or WGS conditions, at least some of the CO may b disproportionated via the Boudouard reaction,

2CO→CO₂+C. (14)

Reaction conditions can be optimized such that the disproportionation yields high quality graphite in lieu of amorphous carbon.

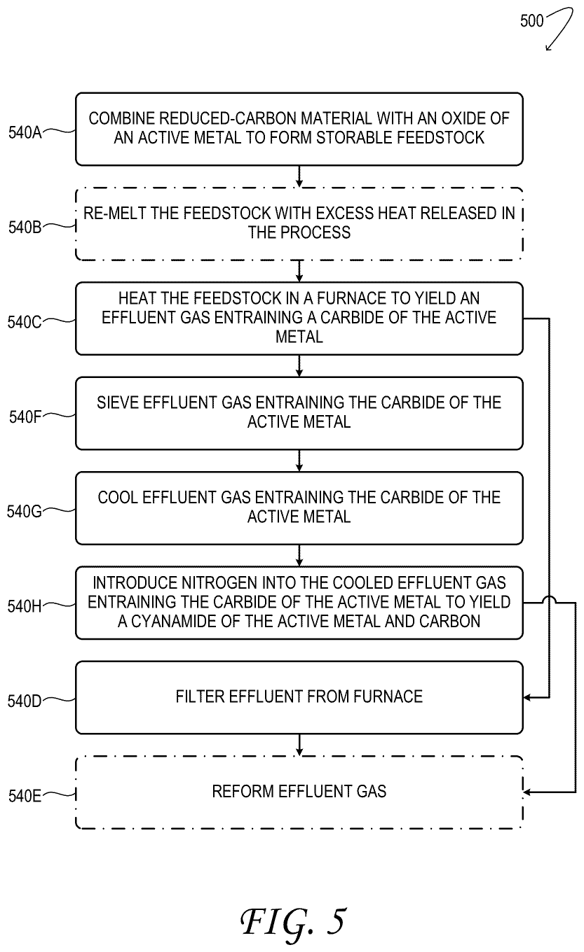

FIG. 5 shows aspects of an example method 500 for making an active-metal carbide suitable for use in purification method 400 or elsewhere in this disclosure. In some examples, aspects of method 500 may represent a more particular implementation of optional step 440G of method 400.

At 540A of method 500, reduced-carbon material is combined with an oxide of an active metal to form a storable feedstock for high-temperature processing. As used herein, a ‘reduced-carbon material’ is any material comprising carbon in an oxidation state less than or equal to zero. The skilled reader is reminded that the oxidation-state formalism assigns an oxidation state of +1 to hydrogen when bonded to a more electronegative atom, assigns an oxidation state of −2 to oxygen when bonded to a less electronegative atom, and assigns an oxidation state of zero to every atom in an elemental state. Accordingly, carbohydrates and elemental carbon both qualify as reduced-carbon material because the carbon therein has an oxidation state of zero. Non-limiting examples of reduced-carbon material include coke, coal, and charable material such as biomass, waste plastic, roof shingle, and motor-vehicle tires. In examples in which the reduced-carbon material comprises biomass, the biomass may include plant and animal products of all kinds, including waste products. One form of charable organic material of particular interest, due to its great abundance and high content of hydrogen, is lignin derived from the paper industry.

In some examples, hydrocarbon gas may be a source of the reduced-carbon material, at least in part. For instance, hydrocarbon gas may be processed under controlled conditions to yield carbon monoxide, and the carbon monoxide may be disproportionated downstream of the oxidation to yield elemental carbon via the Boudouard reaction,

2CO→C+CO₂. (15)

Suitable conditions for forming carbon monoxide from hydrocarbon gas include steam reforming and/or aerobic oxidation. In these and other examples, the Bosch reaction may be used to provide elemental carbon from CO₂, using hydrogen as a reductant,

CO₂+2H₂→C+2H₂O. (16)

Similarly, the Sabatier process may be used to convert CO₂ into reduced carbon, again using hydrogen as a reductant,

CO₂+4H₂→CH₄+2H₂O. (17)

In some examples, the hydrogen input for any of the above processes may be electrolytically derived or captured from the discharge of a plasma/arc reactor, as noted hereinafter.

The term ‘active metal’ refers generically to metallic elements of groups IA and IIA of the Periodic Table of the Elements. In more particular examples, this term may be restricted to relatively abundant and toxicologically and environmentally benign elements from groups IA and IIA—such as sodium, potassium, magnesium, and calcium. In some examples, accordingly, the oxide of the active metal includes CaO. In some examples, the oxide of the active metal includes sodium oxide (Na₂O). In some examples, the oxide of the active metal may include a mixture of oxides of different active metals.

As noted above, the reduced-carbon material in some examples may include waste plastic. Non-limiting examples of waste plastic include polypropylene (PP), polyethylene (PE), polystyrene, polyethylene terephthalate (PET), nylon, polyvinylchloride (PVC), acrylonitrile butadiene styrene (ABC), poly (methyl methacrylate) (PMMA), polycarbonate (PC), and polytetrafluoroethylene (PTFE). More generally, waste plastic may include any commonly used thermoplastic polymer or copolymer material or mixture thereof. In some examples, the thermoplastic polymer or copolymer material may be combined with thermosetting and/or cross-linked polymer materials and/or non-polymeric plasticizers. Alternatively or in addition, the reduced-carbon material may include non-plastic components, such as roof shingle and/or motor-vehicle tires.

The reduced-carbon material may be combined with the oxide of the active metal in any suitable manner. The reduced-carbon material may be conducted through a chipper and therein chipped to a desirable particle size distribution prior to combination with the oxide of the active metal, for instance. In other examples, the reduced-carbon material may be shredded or otherwise broken into fragments of suitable size. Active-metal oxide that is crushed, ground, and/or sieved to a suitable particle size may be combined with the fragmented reduced-carbon material at controlled proportions required for subsequent reaction of the feedstock.

In some examples, the reduced-carbon material may be heated to a melting or softening temperature before or during blending with the active metal oxide. The mixture of the reduced-carbon material and the active-metal oxide then may be extruded. In some examples, the extrusion process itself may release heat sufficient to soften the reduced-carbon material. By this or any other suitable encapsulation mechanism, the active-metal oxide is encapsulated in the reduced-carbon material, in the extruded material. Extrusions of feedstock comprising controlled proportions of blended reduced-carbon material and active-metal oxide may be cut or otherwise segmented to any desired length and stored until needed.

Storage of the active-metal oxide encapsulated in the reduced-carbon material admits of several advantages. First, encapsulation in reduced-carbon material may protect the active-metal oxide from ambient water vapor and carbon dioxide, especially if the reduced-carbon material is hydrophobic. The term ‘hydrophobic’ is applied herein to any material that is substantially water-repellant, water-insoluble and/or non-water-absorbing. Non-limiting examples of hydrophobic materials include waste plastic, roof shingle, and motor-vehicle tires. Without benefit of the encapsulation, exposure of an active-metal oxide to atmospheric constituents is liable to degrade the material to the corresponding hydroxide—e.g.,

CaO+H₂O→Ca(OH)₂, (18)

and/or carbonate,

CaO+CO₂→CaCO₃. (19)

Second, encapsulation enables the active-metal oxide to be stored in a more environmentally responsible manner, as stored, encapsulated oxide material is less likely than non-encapsulated oxide material to be washed into a waterway in the event of excessive rainfall or flooding.

Third, the encapsulated material can be stored with the desired proportion of the active-metal oxide to the reduced-carbon material ‘locked in’ for subsequent reaction. This feature is valuable because method 500 may be engineered to consume various different active-metal oxides and various different forms of reduced-carbon material, even in the same production run. However, the optimal proportion of active-metal oxide to reduced-carbon material may vary depending on the forms being combined. Therefore, storage of the constituents already blended at the correct proportion and encapsulated alleviates the need for precise, variable metering of the constituents as they enter the feedstock-reactor system (vide infra).

In method 500, the carbon content of the reduced-carbon material is extracted and incorporated into a usable product. Accordingly, the feedstock need not include any source of carbon apart from the reduced-carbon material itself. In some examples, however, the overall conversion efficiency of method 500 may be improved by addition of elemental carbon to the feedstock. More particularly, the feedstock may include elemental carbon formed as a by-product of formation of the cyanamide intermediate and subsequently separated from the product, as described further below. The elemental carbon may be included in the blending and extrusion operations noted above. In examples in which elemental carbon is included in the feedstock, the proportion of reduced-carbon material relative to active-metal oxide may be reduced to account for stoichiometric reaction of the elemental carbon with the active-metal oxide.

Subsequently in method 500, the feedstock is conveyed into a furnace for high-temperature processing. Generally speaking, the feedstock may be conveyed in any suitable form. The feedstock may be augured in solid form, for instance. Conveyance in softened solid, semisolid, and liquid forms is also envisaged. In some examples, the feedstock may be conveyed in the form of droplets or a continuous stream. At 540B, accordingly, the feedstock is optionally re-melted with excess heat released in method 500, to facilitate conveyance into the furnace as a softened solid, semisolid, or liquid. The excess heat used to re-melt the feedstock may comprise heat recovered from effluent-gas cooling or from any other point in the process (vide infra).

At 540C of method 500, the feedstock is heated in a furnace to yield an effluent gas entraining a carbide of the active metal. In a typical example, the feedstock is pre-heated in a chamber maintained at a relatively high pressure P₁. The feedstock may be heated to any temperature or range of temperatures suitable to pre-condition the feedstock for subsequent high-temperature heating. In one non-limiting example, the feedstock may be pre-heated to about 1300° C. The subsequent high-temperature heating may be enacted within an electric-arc furnace, although other furnace types are also envisaged. In some examples, an electric-arc furnace or other high-temperature heating stage may reach a temperature of about 2200° C. In examples in which the oxide of the active metal comprises calcium oxide, the reaction yields calcium carbide,

CaO+3C(from reduced-carbon material)→CaC₂+CO. (21)

Other active-metal carbides, such as magnesium carbide, may be formed in the same manner.

Some reduced-carbon materials, such as waste plastics, include chlorinated and/or fluorinated polymers. Without tying this disclosure to any particular theory, it is believed that the halogen component of the feedstock will associate with the active metal under the aggressive thermal conditions of Eq 21, forming halide salts of the active metal—e.g., CaCl₂, CaF₂. This reaction pathway has been proposed in reported carbide synthesis using waste plastic in the feedstock. This provides at least the advantage of averting fluorinated and/or chlorinated hydrocarbon emission from the process. Moreover, CaCl₂ (and by inference CaF₂) is known to act as a flux for certain biphasic reactions—e.g., the reaction of CaC₂ with N₂, to form calcium cyanamide. Accordingly, the presence of a CaCl₂ and/or CaF₂ impurity in the CaC₂ may provide an additional advantage in scenarios in which the reduced-carbon material includes chlorinated and/or fluorinated waste plastic.

In examples in which the feedstock is heated in an electric-arc furnace, the furnace may be ignited from an initial cold state by initiating an arc discharge through the gas within the furnace. Once the electric-arc furnace is in operation, gas released by the decomposition of the reduced-carbon material and/or admitted as carrier gas (vide infra) will serve to sustain the arc. Such gas may include hydrogen, although various other arc-sustaining gasses are also envisaged. In some scenarios, accordingly, a portion of the effluent gas may be retained in the furnace to improve arc-heating efficiency.

In these and other examples, the feedstock may be heated under a flow of carrier gas admitted either to the furnace or fluidically upstream of the furnace. In examples in which a carrier gas is employed, the effluent gas that emerges from the furnace entraining the active-metal carbide includes the carrier gas. The carrier gas may be any gas that does not react with the active-metal oxide reactant or with the active-metal carbide intermediate at the operating temperatures of the furnace. In some examples, the carrier gas includes one or more of the inert gasses helium and argon. Alternatively or in addition, the carrier gas may include one or more of hydrogen and carbon dioxide, for instance.

In some examples, the rate of introduction of the carrier gas is controlled so as to influence the reaction kinetics of one or more stages of method 500. Such stages may include active-metal carbide formation at 540C and/or subsequent reaction of the active-metal carbide (vide infra). Generally speaking increasing dilution with carrier gas reduces the rate of active-metal carbide formation because it cools the furnace. However, dilution may reduce the particle size distribution of the active-metal carbide intermediate, which increases the rate of the subsequent heterogeneous reaction of the intermediate.

Continuing now in FIG. 5, at 540D, the effluent gas is subjected to a filtration operation, wherein the particles of the entrained active-metal carbide are size-selected upon discharge from the furnace. More particularly, only particles of sufficiently small size may be permitted to exit the furnace, thereby excluding highly agglomerated particles that may be less reactive. In some examples, particles less than 100 microns, more preferably less than 20 microns, may be selected. At optional step 540E the effluent gas from the electric-arc furnace is subjected to reforming conditions, to make additional hydrocarbon—e.g.,

CO+3H₂→CH₄+H₂O. (22)

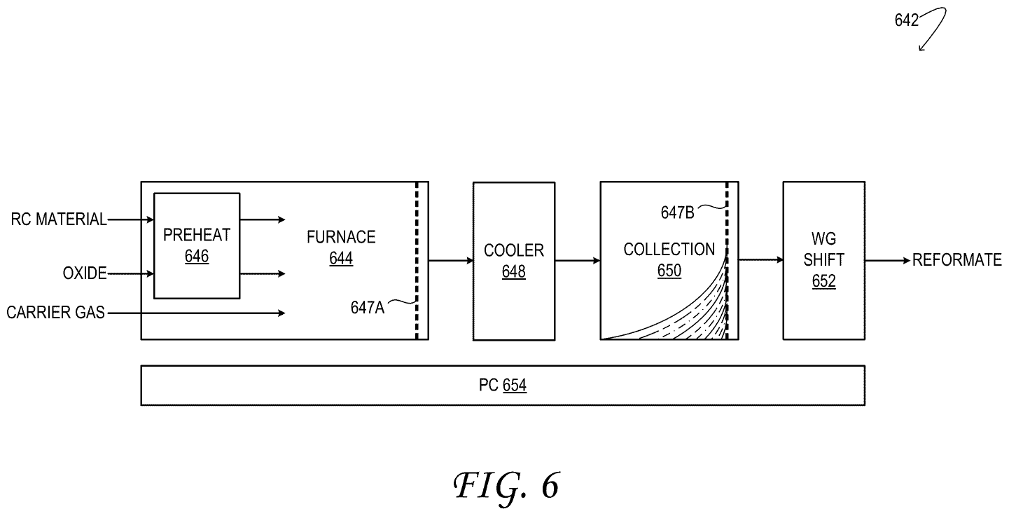

FIG. 6 shows aspects of an example carbide unit 642 that may be used in connection with method 500. The carbide unit includes furnace 644 having a pre-heater 646. The pre-heater is configured to receive active-metal oxide and reduced-carbon material and to pre-heat the active-metal oxide and the reduced-carbon material to a temperature suitable for entry into the electric-arc portion of the furnace. The electric-arc portion is configured to receive pre-heated active-metal oxide and reduced-carbon material from the pre-heater together with the carrier gas, if any, used in method 500. More specifically, the electric-arc portion is configured to heat the pre-heated active-metal oxide, reduced-carbon material, and carrier gas to a temperature at which Eq 21 occurs with favorable kinetics. In some examples, the furnace may comprise a rotating arc and/or hollow-electrode electric-arc. In the illustrated example, size-exclusion sieve 647 is arranged fluidically downstream of the electric-arc portion, to transmit only those particles of a mesh-size range appropriate for method 400 and to retain coarser particles. In some examples the electric-arc furnace is powered by energy derived from the purified hydrocarbon gas—i.e., sweet hydrocarbon gas from which the hydrogen sulfide has been removed via method 400.

Carbide unit 642 also includes an optional cooler 648, collection chamber 650, and water-gas shift reactor 652. Furnace 644 is configured to discharge the effluent gas entraining size-selected active-metal carbide to cooler 648. The cooler is configured to cool the effluent gas entraining the active-metal carbide and to discharge the cooled effluent gas entraining the active metal carbide to the collection chamber. The collection chamber is configured to receive and retain the cooled effluent gas entraining the active-metal carbide.

Carbide unit 642 also includes a process controller 654. The process controller is configured to receive sensory input from a plurality of sensors arranged in the carbide unit. Such sensors may include temperature sensors, pressure sensors, flow sensors, fill sensors, and the like. The sensors may be arranged on furnace 644, pre-heater 646, cooler 648, collection chamber 650, and/or water-gas shift reactor 652, for example. The process controller is configured to provide control output to a plurality of actuators arranged in the carbide unit. Such actuators may include flow actuators that control the flow of carrier gas, or the flow between fluidically connected components of the carbide unit. Other actuators may include heating actuators for furnace 644, pre-heater 646, collection chamber 650, and/or water-gas shift reactor 652, and cooling actuators for cooler 648, for example. Process controller 654 includes a computer system configured to execute a process for controlling any, some, or all of the control outputs based on any, some, or all of the sensory inputs, and further based on desirable process setpoints and/or input from a human operator. In some examples, the process controller may be configured to control any, some, or all of the control outputs in a closed-loop manner, based on any, some, or all of the sensory inputs and/or process setpoints.

As noted hereinabove, processing via Eqs 6-8, or the like, may be used to recover the sulfur from the CaS by-product of Eq 3 and to regenerate the CaO for CaC₂ synthesis. In that approach the sulfur ‘carrier’ is H₂S, which is highly toxic. Described below is an alternative sulfur-recovery method, which avoids the accumulation of a significant quantity of H₂S. The alternative method uses a first portion of the CaC₂ product of method 500 as the scrubber and subjects a second portion of the CaC₂ product to further processing. For ease of illustration, such further processing is also illustrated in FIG. 5. It will be understood, however, that the foregoing aspects of method 500 may be used separately from, or together with, the additional aspects described hereinafter.

Returning again to FIG. 5, at optional step 540F, the effluent gas is subjected to a sieving operation, wherein the particles of the entrained active-metal carbide intermediate are size-selected upon discharge from the furnace. More particularly, only particles of sufficiently small size may be permitted to exit the furnace, thereby excluding highly agglomerated particles that may be less reactive. In some examples, particles less than 100 microns, more preferably less than 20 microns, may be selected.

At 540G the effluent gas entraining the carbide of the active metal is cooled. More particularly, the effluent gas is cooled to a temperature suitable for subsequent transformation of the active-metal carbide into a corresponding active-metal cyanamide. In some examples, the effluent gas is cooled to about 1000° C. In some examples, cooling of the effluent gas may be effected by separating a portion of the flow of the effluent gas, actively or passively cooling that portion, and then re-introducing the cooled portion into the balance of the flow. The separated flow may be cooled by flowing through an air-or water-cooled chamber, for instance, or by flowing through an active heat exchanger.

Alternatively or in addition, the effluent gas entraining the active-metal carbide may be cooled via expansion. In particular, the effluent gas entraining the active-metal carbide may be discharged from the furnace into a chamber of pressure P₂, which is lower than P₁. Such cooling yields the carbide of the active metal in a controlled particle-size distribution. The reader will note that because the particle size distribution of the active-metal carbide is a function of the flow rate (vide supra), it is therefore also a function of the pressure differential P₁-P₂.

Alternatively or in addition, the effluent gas entraining the active-metal carbide may be cooled by mixing with an endothermically decomposable gas. More particularly, an endothermically decomposable gas may be introduced into the flow of the effluent gas emerging from the furnace. Examples of suitable endothermically decomposable gasses include light hydrocarbons, such as methane, ethane, and propane, and mixtures thereof. At temperatures above 900° C., for example,

CH₄→C+2H₂ (23)

occurs spontaneously and absorbs significant heat. At lower temperatures, however, the reaction is non-spontaneous. Accordingly, introduction of one or more hydrocarbons, such as methane, is expected to cool the effluent gas entraining the active-metal carbide to temperatures appropriate for subsequent reaction, as described below.

At 540H nitrogen is introduced into the cooled effluent gas entraining the carbide of the active metal, to yield a cyanamide of the active metal and elemental carbon. In examples in which calcium carbide is entrained in the cooled effluent gas, the cyanamide product is calcium cyanamide,

CaC₂+N₂→CaCN₂+C. (24)

As noted briefly hereinabove, Eq 24 represents the Franck-Caro process for conversion of calcium carbide to calcium cyanamide. Analogous reactivity is expected for active metals besides calcium, that form acetylide-type carbides under the conditions of Eq 21. An acetylide-type carbide is a carbide having a relatively short C—C bond length, which reacts spontaneously with water to form acetylene. Analogous reactivity may also be observed for active metals that form non-acetylide-type carbides, such as magnesium.

In some examples, nitrogen may be introduced to the effluent gas entraining the active-metal carbide in a fluidized-bed reactor, where the nitrogen and the effluent gas are passed through the granular active-metal carbide at a velocity high enough to suspend the solid in a pseudofluid state. In some examples, introducing nitrogen to the cooled effluent gas includes maintaining a positive (e.g., high-velocity) flow of the effluent gas to prevent backflow of the nitrogen into the furnace. This can be achieved by discharging the fluidized-bed reactor into a chamber of pressure P₃ that is lower than P₂. This strategy not only discourages the backflow of nitrogen into the furnace (which could result in the formation of an active-metal cyanide) but also enables additional cooling of the active metal cyanamide intermediate via further expansion of the effluent gas. In some examples, the gas at P₃ may cool by expansion to less than 900° C.

The CaCN₂ product of method 500 dissolves in water with significant hydrolysis. Generally speaking, a cyanamide of an active metal (M) may acidically hydrolyze to yield a cyanamide compound and a salt of the active metal—e.g.,

MₙCN₂+2H⁺→NH₂CN+nM⁽³⁻ⁿ⁾⁺, (25)

where NH₂CN corresponds to the cyanamide monomer. In some examples and scenarios, aqueous carbon dioxide is sufficiently acidic to promote the hydrolysis, although other acids may be used instead, or in addition. Accordingly, CaCN₂, in an aqueous slurry, is a source of the cyanamide monomer NH₂CN, which reacts spontaneously with S²⁻ to form thiourea, (NH₂)₂CS, as a stable product,

NH₂CN+S²⁻+2H⁺→(NH₂)₂CS. (26)

Thus, an aqueous slurry of CaCN₂ can be used to neutralize at ambient temperatures any accumulated CaS formed in acid scrubber 308 via Eq 3,

NH₂CN+CaS+2H⁺→(NH₂)₂CS+Ca²⁺. (27)

Like CaS, thiourea can be used as a carrier for transporting sulfur. Unlike CaS, thiourea has manageable toxicity and is a valuable commodity chemical. Thiourea is used in metal processing, for instance, for extracting gold and silver from their ores, and as a complexing agent in analytical chemistry. Thiourea is also used in the textile industry as a reducing agent and a component of some dye formulations. Thiourea is a component of photographic fixing baths and is a precursor in the synthesis of various organic compounds, including pharmaceuticals, herbicides, and pesticides. Thiourea is also used in some formulations of fertilizers, as a source of nitrogen.

Because Eqs 26 and 27 are spontaneous, CaCN₂ or NH₂CN may be usable, as alternatives to CaC₂, for scrubbing H₂S from hydrocarbon gas. The reaction of cyanamides with H₂S is also spontaneous but is typically observed in the solution state. In scenarios in which CaCN₂ is used to scrub H₂S, a Brønsted-Lowry acid is also required,

CaCN₂+H₂S+2H⁺→(NH₂)₂CS+Ca²⁺ (28)

A convenient Brønsted-Lowry acid is H₂CO₃, which drives Eq 28 to the right by precipitation of CaCO₃. Generally speaking, basic conditions are to be avoided in this application of the cyanamide compounds: the cyanamide monomer itself dimerizes under basic conditions to yield 2-cyanoguanidine (2-CG),

2NH₂CN→2−CG+H⁺, (29)

which can be dimerized again to form melamine.

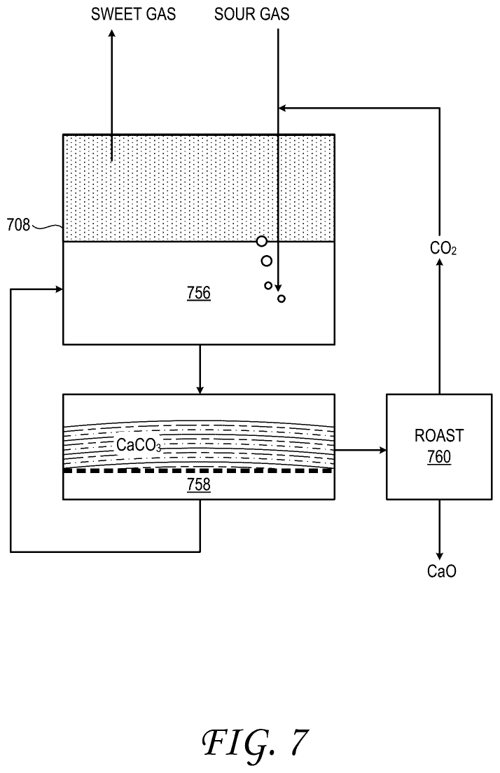

FIG. 7 shows aspects of an example acid scrubber 708 that can be used as an alternative, or in addition, to acid scrubber 308 of FIG. 3. Acid scrubber 708 is charged with an aqueous slurry 756 of CaCN₂, to which sour gas is admitted. The sour gas admitted to acid scrubber 708 may be further acidified to a controlled degree by addition of CO₂, to facilitate Eq 28. Stirring and/or vibration may be used to supplement the convection due to sparging. Sweet gas is thereby released from the acid scrubber, in addition to excess CO₂ and water vapor. Removal of H₂S causes the accumulation of thiourea (soluble in 11 parts water) in the aqueous slurry and the gradual conversion of CaCN₂ to CaCO₃. Periodically, the slurry may be withdrawn from acid scrubber 708 and subject to filtration in filtration unit 758, where the CaCO₃ precipitate is removed. The CaCO₃ can be roasted in roasting unit 760 to regenerate CaO according to Eq 8.

In some examples acid scrubber 708 may include componentry not particularly illustrated in FIG. 7. Such componentry may include inlet valves for controlling inlet of the cyanamide slurry, sour gas, and/or CO₂, outlet valves for controlling discharge of the slurry to filtration unit 758 and recirculation of the same, one or more level sensors for preventing overfill of the acid scrubber and filtration unit, and/or various holding tanks. The acid scrubber may also include an H₂S sensor and/or pH sensor configured to pause operation of the scrubber when the H₂S-absorbing capacity of the slurry is exceeded. Finally, the acid scrubber may include thermal-regulation componentry to regulate the slurry temperature to within a desired range. In some examples the range may be 60 to 80° C., although higher and lower, broader and narrower ranges are also envisaged.

In examples in which any, some, or all of the CaC₂ formed in method 500 is converted into cyanamide products, the amount of carbon available for recapture may exceed the amount carried in furnace effluent. This is because Eq 24 yields two equivalents of elemental carbon for every equivalent of the carbide consumed. In typical examples, the elemental carbon by-product of Eq 24 is carried along with the CaCN₂ through subsequent reaction in acid scrubber 708. This presents no particular disadvantage because the elemental carbon is substantially non-reactive under the relevant conditions. In examples in which carbonic acid is used for the hydrolysis, the product is an intimate mixture of calcium carbonate and amorphous carbon.

An alternative to separation of the mixture is to pass superheated CO₂ from Eq 13 through the mixture,

CO₂+CaCO₃+2C→CaO+4CO. (30)

Based on the reverse-Boudouard reaction, the conversion above regenerates the active-metal oxide starting material. The CO released in Eq 30 may be combined with the furnace effluent, thereby increasing both the reducing capacity and carbon content of the effluent. The Boudouard reaction can be catalyzed in both directions using transition-metal catalysts.

In other examples, it may be desirable to separate the elemental carbon from the CaCO₃ and process these solids separately. For instance, solid residue comprising CaCO₃ and elemental carbon may be separated from aqueous solution by filtration. The CaCO₃ may be redissolved with high selectivity in aqueous CO₂ (e.g., at elevated temperature and pressure) and re-precipitated to yield purified CaCO₃, from which the CaO starting material can be regenerated. Only the fraction that does not dissolve in aqueous CO₂ may be subjected to Boudouard conversion. The mineral residue that does not dissolve in aqueous CO₂ may contain impurities that should not be returned to the furnace. In examples in which the initial carbon source is agricultural waste, the mineral residue may contain elements that may be returned to the soil.

Conversion of CaC₂ into CaCN₂ is highly exothermic. Thus, extraction of the heat released in Eq 24 may provide additional value. Such heat may be used, for instance, to decompose a light hydrocarbon to make additional hydrogen—e.g.,

2CH₄→CH₃CH₃+H₂. (31)

Likewise, the effluent from the furnace also carries valuable, recoverable heat, which may be extracted and used in various ways in integrated processes.

The carbon dioxide produced in Eqs 13-15 can be utilized variously. For instance it can be used to cool the reaction chamber for Eq 24 and to limit agglomeration of the CaC₂ starting material or CaCN₂ product. At least some of the CO₂ may be used as a source of carbonic acid for Eqs 26-28. To further increase efficiency, waste heat from the furnace and/or Eq 24 may be redirected to a WGS reactor. Sorption-enhanced WGS can also be used to further increase efficiency.

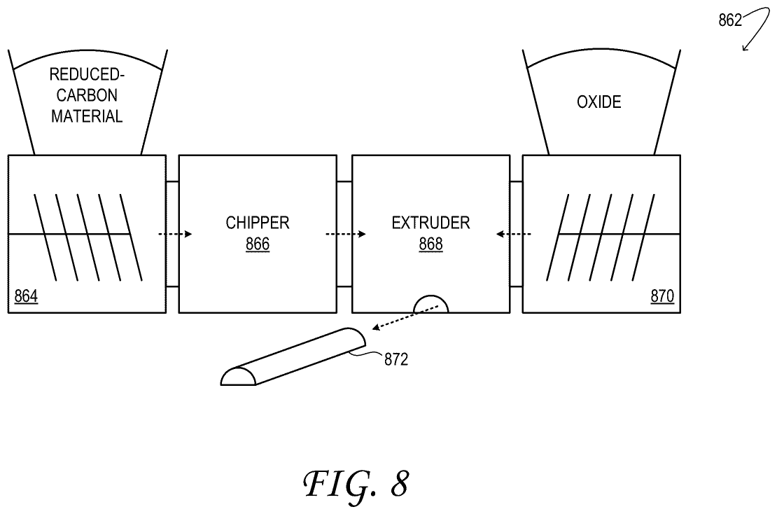

FIG. 8 shows aspects of an example feedstock-preparation system 862 that may be used in connection to method 500. The feedstock-preparation system includes a reduced-carbon hopper 864 and a chipper 866. The reduced-carbon hopper is configured to receive reduced-carbon material and to convey the reduced-carbon material to the chipper. The chipper is configured to chip the reduced-carbon material into particles of a desired particle-size distribution.

Feedstock-preparation system 862 also includes an extruder 868 and an active-metal-oxide hopper 870. The extruder is configured to receive the chipped reduced-carbon material from chipper 866 and to receive active-metal oxide from the active-metal-oxide hopper. The extruder is configured to mechanically combine and intimately blend the chipped reduced-carbon material and the active metal oxide and to force the blended mixture through an orifice to form an extrusion 872 of active-metal oxide encapsulated in reduced-carbon material, which is suitable for use as a feedstock in method 500. In some examples, the extruder may be configured also to receive elemental carbon for incorporation into the feedstock.

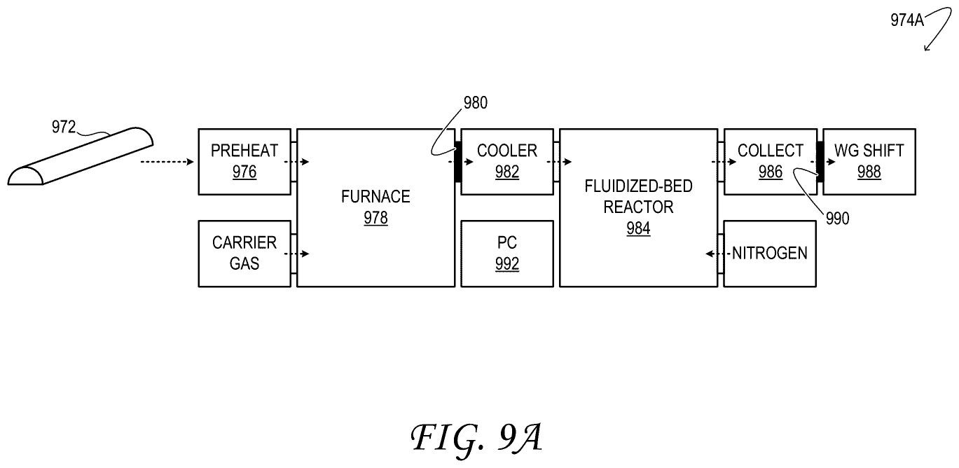

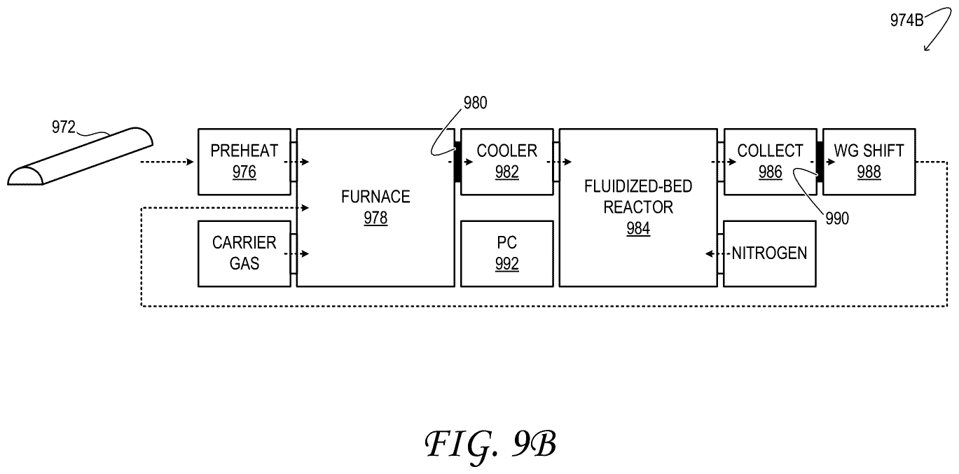

FIG. 9A shows aspects of an example feedstock-reactor system 974A that may be used in connection to method 500. The feedstock-reactor system includes pre-heater 976 and a furnace 978. The pre-heater is configured to receive feedstock material and to pre-heat the feedstock material to a temperature suitable for entry into the furnace. The furnace is configured to receive pre-heated feedstock material from the pre-heater together with the carrier gas used in method 500. The furnace is configured to heat the pre-heated feedstock material and the carrier gas to a temperature at which Eq 21 occurs with favorable kinetics. In some examples, the furnace may comprise an electric-arc furnace. In more particular examples, the furnace may comprise a rotating arc and/or hollow-electrode electric-arc furnace. In the illustrated example, a size-exclusion sieve 980 is arranged fluidically downstream of the furnace.

Feedstock-reactor system 976A also includes an optional cooler 982 and fluidized-bed reactor 984. Furnace 978 is configured to discharge the effluent gas entraining the active-metal carbide to cooler 982. In some examples, the effluent gas may be discharged through a sieve that achieves size selection of the entrained particles of the active-metal carbide. The cooler is configured to cool the effluent gas entraining the active-metal carbide and to discharge the cooled effluent gas entraining the active metal carbide to the fluidized-bed reactor. In some examples, the cooler is configured to introduce an endothermically decomposable gas into the effluent gas flow. The fluidized-bed reactor is configured to receive the cooled effluent gas entraining the active-metal carbide, to receive also nitrogen, and to facilitate reaction of the nitrogen and the active-metal carbide to form fluidized active-metal cyanamide particles.

Feedstock-reactor system 974A also includes a collection chamber 986 and, optionally, a water-gas shift reactor 988. Fluidized-bed reactor 984 is configured to discharge the effluent gas entraining the active-metal cyanamide to the collection chamber. In the illustrated example, the collection chamber includes a filter 990 or other separation component configured to pass the effluent gas on to the water-gas shift reactor but to retain the active-metal cyanamide. The water-gas shift reactor is configured to convert the CO component of the effluent gas to H₂ (Eq 13). In some examples, optional cracking and/or producer-gas forming stages are arranged within or fluidically upstream of the water-gas shift reactor.

Feedstock-reactor system 976A also includes a process controller 992. The process controller is configured to receive sensory input from a plurality of sensors arranged in the feedstock-reactor system. Such sensors may include temperature sensors, pressure sensors, flow sensors, fill sensors, and the like. The sensors may be arranged on preheater 976, furnace 978, cooler 982, fluidized-bed reactor 984, collection chamber 986 and/or water-gas shift reactor 988, for example. The process controller is configured to provide control output to a plurality of actuators arranged in the feedstock-reactor system. Such actuators may include flow actuators that control the flow of carrier gas and/or nitrogen, or the flow between fluidically connected components of the feedstock-reactor system. Other actuators may include heating actuators for preheater 976, furnace 978, fluidized-bed reactor 984, and/or water-gas shift reactor 988, and cooling actuators for cooler 982, for example. Process controller 992 includes a computer system configured to execute a process for controlling any, some, or all of the control outputs based on any, some, or all of the sensory inputs, and further based on desirable process setpoints and/or input from a human operator. In some examples, the process controller may be configured to control any, some, or all of the control outputs in a closed-loop manner, based on any, some, or all of the sensory inputs and/or process setpoints.

FIG. 9B shows aspects of another example feedstock-reactor system 974B that may be used in connection to method 500. In feedstock-reactor system 974B, a portion of the discharge from water-gas shift reactor 988 is fed back to furnace 978 to supplement the carrier gas admitted to the furnace. That portion may include hydrogen formed in the water-gas shift reactor and/or any non-reactive gas transmitted through the water-gas shift reactor.

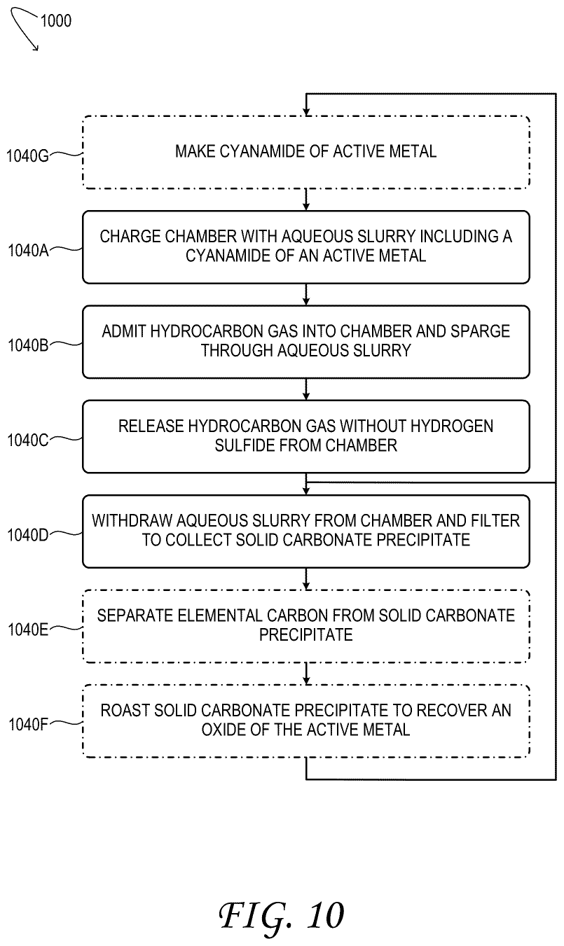

FIG. 10 shows aspects of another example method 1000 to purify a hydrocarbon gas with hydrogen sulfide as an impurity. The method is based on the analysis hereinabove. In some examples method 1000 may be enacted in an apparatus such as acid scrubber 708 of FIG. 7. Other acid-scrubbing configurations are also envisaged.

At 1040A of method 100 a chamber is charged with an aqueous slurry including a cyanamide of an active metal. In some examples the active metal may comprise calcium and/or magnesium.

At 1040B hydrocarbon gas is admitted into the chamber and sparged through the aqueous slurry. In some examples stirring and/or vibration may be used together with the sparging. Generally speaking, the aqueous slurry includes an acid. In some examples the acid comprises carbonic acid from carbon dioxide admitted into the chamber along with (or prior to) the sour hydrocarbon gas.

At 1040C the hydrocarbon gas without the hydrogen sulfide is released from the chamber. At 1040D the aqueous slurry is withdrawn from the chamber, at suitable intervals, and filtered to collect a solid carbonate precipitate of the active metal.

In some examples the aqueous slurry collected in this manner may comprise elemental carbon—a by-product of cyanamide synthesis. At optional step 1040E the elemental carbon may be separated from the solid carbonate precipitate. This step is not strictly necessary, however, because, in other examples, the elemental carbon may be carried through to subsequent roasting step, where the oxide of the active metal is recovered. At optional step 1040F, accordingly, the solid carbonate of the active metal is roasted to recover the active-metal oxide.

In some examples method 1000 may include the optional step 1040G of making the cyanamide of the active metal via the oxide of the active metal recovered as described above, together with a reduced-carbon source.

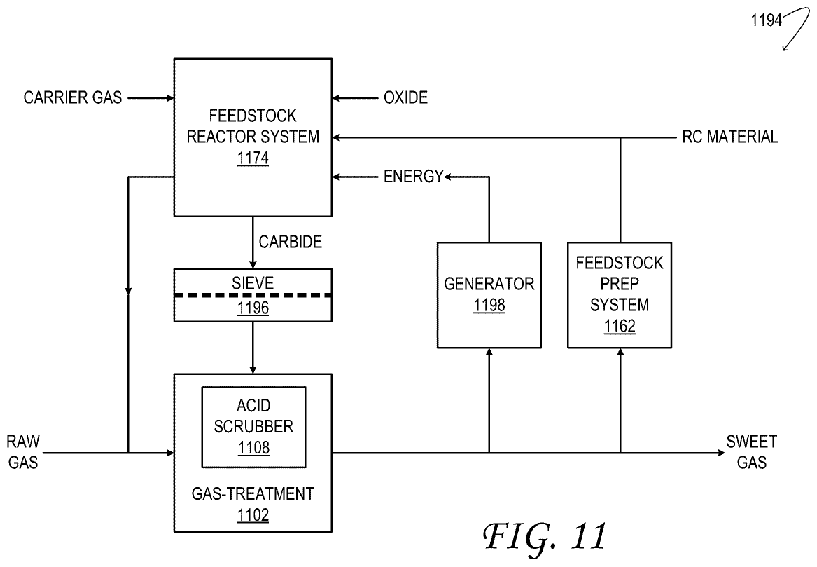

FIG. 11 shows, in the form of processing facility 1194, an implementation environment for the methods and configurations herein. Processing facility 1194 comprises a gas-treatment facility 1102 including an acid scrubber 1108, a feedstock-reactor system 1174, sieve 1196, generator 1198, and feedstock-preparation system 1162. The sieve is configured to sieve the active-metal carbide to the predetermined mesh-size range. The generator makes power.

No aspect of the foregoing drawings or description should be interpreted in a limiting sense, because numerous variations, extensions, and omissions are also envisaged. For instance, certain forms of reduced-carbon material may contain significant amounts of sulfur. Examples include motor-vehicle tires, which are made of vulcanized rubber. When the tires are pyrolyzed, hydrogen sulfide and other sulfur compounds may be discharged from the tires. Such gas may be passed over or through an acid scrubber as described herein in order to trap the sulfur.

As shown in FIG. 6, effluent gas from a carbide unit, which comprises CO, may be passed over a water-gas shift catalyst, to yield hydrogen,

CO+H₂O→CO₂+H₂. (32)

The mode of utilization of the hydrogen from Eq 32 is not particularly limited. In some examples, the hydrogen may be included in the stream of carrier gas supplied to feedstock-reactor system 1174. Incorporation of hydrogen into the carrier gas may be more desirable than incorporation of methane itself, which may contain impurities that introduce undesirable process variables. In other examples, the hydrogen may be consumed in a reforming process or converted to heat or electrical energy for the electric-arc furnace, or elsewhere in method 500.

In some examples, the energy needed to make the active-metal carbide can be derived from purified hydrocarbon gas itself. In other examples, the energy can be wind- or solar-derived. The active-metal component of the active-metal carbide can be recycled indefinitely, as described hereinabove. Further, as virtually any reduced-carbon material can serve as the carbon source, the end-to-end process does not require extensive material transport. Charring, as needed, may be accomplished using energy derived from the purified hydrocarbon gas.

In still other examples, purified hydrocarbon gas may be admitted directly to the arc furnace. It is believed that the hydrocarbon will react with lime to yield refractory calcium carbide and release both hydrogen and carbon monoxide. The interested reader is referred to ‘CaC₂ Production from CaO and Coal or Hydrocarbons in a Rotating-Arc Reactor’ by Chi S. Kim, et al. in Ind. Eng. Chem. Process Des. Dev. Vol. 18, No. 2, 1979. The following additional documents are also referred to:
R. K. Graupner and J. D. Hultine, PRODUCTION AND USE OF CYANOGUANIDINE AND CYANAMIDE, International Patent Application Publication Number WO 2012/123378 A1, 20 Sep. 2012.
R. K. Graupner and J. D. Hultine, PRODUCTION AND USE OF CYANOGUANIDINE AND CYANAMIDE, International Patent Application Publication Number WO 2012/123380 A2, 20 Sep. 2012.
J. Dustin Hultine and Robert Kurt Graupner, INTEGRATED SYNTHESIS OF COMMODITY CHEMICALS FROM WASTE PLASTIC, U.S. Pat. No. 11,180,371 B2, 23 Nov. 2021.

It will be understood that the configurations and/or approaches described herein are exemplary in nature, and that these specific examples are not to be considered in a limiting sense, because numerous variations are possible. The specific routines or methods described herein may represent one or more of any number of processing strategies. As such, various acts illustrated and/or described may be conducted in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method to purify a hydrocarbon gas, the method comprising:
obtaining the hydrocarbon gas, such hydrocarbon gas having hydrogen sulfide as an impurity;
charging a chamber with a bed of active-metal carbide of a predetermined mesh-size range;
conducting the hydrocarbon gas through the bed of active-metal carbide, forming additional hydrocarbon gas and a sulfide of the active metal, by reaction of the active-metal carbide and the hydrogen sulfide;
filtering from the chamber the hydrocarbon gas without the hydrogen sulfide; and
treating the sulfide of the active metal with a cyanamide compound and an acid, thereby forming thiourea.

2. The method of claim 1 wherein the acid comprises carbonic acid from carbon dioxide and water, and wherein treating the sulfide yields a solid carbonate precipitate of the active metal.

3. The method of claim 2 further comprising separating the thiourea from the solid carbonate precipitate.

4. The method of claim 1 wherein the additional hydrocarbon gas comprises one or more of acetylene, methane, methylacetylene, and propadiene.

5. The method of claim 1 wherein the active-metal carbide includes calcium carbide and/or a magnesium carbide.

6. The method of claim 1 further comprising forming still more hydrocarbon gas by reaction of the active-metal carbide and one or more acid impurities of the hydrocarbon gas besides hydrogen sulfide.

7. The method of claim 1 further comprising making the active-metal carbide.

8. The method of claim 7 further comprising sieving the active-metal carbide to the predetermined mesh-size range.

9. The method of claim 7 wherein the active-metal carbide is a carbide of an active metal, and wherein making the active-metal carbide includes heating reduced-carbon material and an oxide of an active metal in an electric-arc furnace.

10. The method of claim 7 further comprising subjecting effluent gas from the electric-arc furnace to reforming conditions, to make still more hydrocarbon gas.

11. The method of claim 7 wherein making the active-metal carbide comprises making a first portion of the active-metal carbide for the bed and making a second portion of the active-metal carbide for downstream processing, the method further comprising making the cyanamide compound via the downstream processing.

12. The method of claim 11 wherein making the active-metal carbide comprises making from an oxide of the active metal and a reduced-carbon source, wherein the cyanamide compound comprises a cyanamide of the active metal, wherein the acid comprises carbonic acid, and wherein treating the sulfide yields a solid carbonate precipitate of the active metal derived from the first and second portions of the active-metal carbide, the method further comprising:
separating the thiourea from the solid carbonate precipitate.

13. The method of claim 12 further comprising roasting the solid carbonate precipitate to recover an oxide of the active metal.

14. A processing facility to purify a hydrocarbon gas having hydrogen sulfide as an impurity, the processing facility comprising:
a chamber configured to receive a flow of the hydrocarbon gas;
a bed arranged in the chamber, configured to intercept the flow of the hydrocarbon gas;
an active-metal carbide of a predetermined mesh-size range arranged in the bed, the active-metal carbide configured to form additional hydrocarbon gas and a sulfide of the active metal, by reaction with the hydrogen sulfide;
arranged in the chamber fluidically downstream of the bed, a filter configured to retain the active-metal carbide and to transmit the hydrocarbon gas without the hydrogen sulfide; and
a regenerator configured to treat the sulfide of the active metal with a cyanamide compound and an acid, thereby forming thiourea.

15. The processing facility of claim 14 wherein the acid comprises carbonic acid from carbon dioxide and water, and wherein treating the sulfide yields a solid carbonate precipitate of the active metal.

16. The processing facility of claim 15 wherein the regenerator is further configured to separate the thiourea from the solid carbonate precipitate.

17. A method to purify a hydrocarbon gas, the method comprising:
obtaining the hydrocarbon gas, such hydrocarbon gas having hydrogen sulfide as an impurity;
charging a chamber with an aqueous slurry including a cyanamide of an active metal;
admitting the hydrocarbon gas into the chamber and sparging the hydrocarbon gas through the aqueous slurry, wherein the aqueous slurry includes an acid; and
releasing the hydrocarbon gas without the hydrogen sulfide from the chamber.

18. The method of claim 17 wherein the active metal comprises calcium and/or magnesium.

19. The method of claim 17 wherein the acid comprises carbonic acid from carbon dioxide admitted into the chamber along with the hydrocarbon gas.

20. The method of claim 17 further comprising withdrawing the aqueous slurry from the chamber and filtering the aqueous slurry to collect a solid carbonate precipitate of the active metal.

21. The method of claim 20 further comprising roasting the solid carbonate precipitate to recover an oxide of the active metal.

22. The method of claim 20 wherein the aqueous slurry includes elemental carbon.

23. The method of claim 22 further comprising separating the elemental carbon from the solid carbonate precipitate.

24. The method of claim 21 further comprising making the cyanamide of the active metal from the oxide of the active metal together with a reduced-carbon material.
